(19) United States
(12) Patent Application Publication
(10) Pub. No.: US 2022/0242402 A1
(43) Pub. Date: Aug. 4, 2022

(54) SYSTEM AND METHOD FOR MOBILITY DEVICE SHARING SERVICE

(71) Applicants: Hyundai Motor Company, Seoul (KR); Kia Corporation, Seoul (KR)

(72) Inventor: Kyung Jin YOU, Whasung-Si (KR)

(73) Assignees: Hyundai Motor Company, Seoul (KR); Kia Corporation, Seoul (KR)

(21) Appl. No.: 17/469,564

(22) Filed: Sep. 8, 2021

(30) Foreign Application Priority Data
Feb. 3, 2021 (KR) 10-2021-0015551

(51) Int. Cl. B60W 30/08; B60W 40/09; H04W 4/40; H04W 8/08; G06Q 50/30

(52) U.S. Cl. CPC B60W 30/08; B60W 40/09; H04W 4/40; B60W 2040/0818; G06Q 50/30; B60W 2030/082; H04W 8/08

(57) ABSTRACT

A mobility device sharing service system and method may include an information receiving unit to receive collision-related information of mobility device, a determination unit to determine the occurrence of collision or the degree of collision, and a user management unit to determine a deduction score with the occurrence of collision or the degree of collision analyzed by the determination unit and to apply the deduction score to a user's score is disclosed.

### CROSS-REFERENCE TO RELATED APPLICATION

The present application claims priority to Korean Patent Application No. 10-2021-0015551, filed Feb. 3, 2021, the entire contents of which is incorporated herein for all purposes by this reference.

### BACKGROUND OF THE INVENTION

### Field of the Invention

In the mobility device sharing service according to the present invention, a score is assigned for each user according to whether or not the collision of mobility device occurs and the degree of collision, the score is changed according to the driving style of the user, and a service cost rate is differently charged for each user. Thus, the present invention relates to a mobility device sharing service system and method that enables efficient service provision from the standpoint of service providers, enables service providers to effectively use and manage a mobility device, and enables users to use a sharing service economically and reasonably.

### Description of Related art

Recently, various eco-friendly vehicles such as electric vehicles and hydrogen vehicles have been developed and distributed for creating eco-friendly society. Furthermore, research and dissemination on a micromobility device such as air mobilities and electric kickboards have been conducted.

Lastly, efforts have been made to define the concept of Last Mile service by providing an integrated sharing solution for such a long-distance mobility device and a short-distance mobility device.

In order to provide a sharing service without inconvenience to users, it has to efficiently manage various repairs and damages of a mobility device.

However, in the case of the collision of mobility device, a repair management system is not yet fully established, and whether a party responsible for the repair and management is a service provider or a user is not specified. Thus, it is very difficult to provide a service economically and reasonably in reality.

Furthermore, the durability of a mobility device is greatly affected by the user's usage environment and driving habits while it is affected by natural aging of a mobility device. Thus, it needs to analyze these factors and differentiate them for each user so that each user can use a sharing service reasonably and economically.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a mobility device sharing service system and method in which a score is assigned for each user according to whether or not the collision of mobility device occurs and the degree of collision, the score is changed according to the driving style of the user, and a service cost rate is differently charged for each user. Accordingly, the mobility device sharing service system and method of the present invention enables efficient service provision from the standpoint of service providers, enables service providers to effectively use and manage a mobility device, and enables users to use a sharing service economically and reasonably.

the mobility device sharing service system according to various exemplary embodiments of the present invention may include an information receiving unit that receives collision-related information of a mobility device from the mobility device, a user terminal, or an infrastructure around the mobility device, a determination unit that analyzes the collision-related information of the information receiving unit to determine whether collision of the mobility device is occurred or degree of the collision, and a user management unit that stores user's customer information, the user's customer information having a score for each user, determines a deduction score based on an occurrence or the degree of the collision analyzed by the determination unit, and applies the deduction score to the user's score.

The information receiving unit may receive the collision-related information from a detection sensor of the mobility device and a detection sensor of the user terminal, and the determination unit may analyze the collision-related information from the mobility device and the user terminal.

The information receiving unit may receive a plurality of types of the collision-related information, and the determination unit may analyze the plurality of types of the collision-related information to determine the degree of the collision.

The determination unit may determine a degree of collision with a number or a type of the collision-related information.

The determination unit may determine a degree of collision with time interval of occurrence of the collision-related information.

The present invention may further include a collision processing unit that transmits a collision notification signal to a mobility device maintenance center or an emergency agency according to the degree of the collision determined by the determination unit.

When the degree of collision is small, the collision processing unit may transmit a collision image received from the mobility device or the user terminal to the mobility device maintenance center.

When the degree of collision is not small, the collision processing unit may transmit location information of the mobility device or the user terminal to the emergency agency.

The collision-related information received from the information receiving unit may include at least one of mobility device impact information, noise information, acceleration information, and safety equipment information.

The collision-related information received by the information receiving unit may include at least one of tilt information and noise information of the user terminal.

The user management unit may update user's cost rate of mobility device sharing service according to changed user's score.

The mobility device sharing service method which utilizes the mobility device sharing service system of the present invention, may include the steps of receiving the collision-related information from the mobility device, the user terminal or the infrastructure around the mobility device by the information receiving unit, analyzing, by the determination unit, the collision-related information of the information receiving unit to determine whether the collision is occurred or the degree of collision, and determining, by the user management unit, the deduction score based on the occurrence of collision or the degree of collision, and applying the deduction score to the user's score.

The method may further include, after the step of applying the deduction score to the user's score, the step of updating a user's cost rate of mobility device sharing service according to the user's score changed by the user management unit.

In the step of determining the degree of collision, a degree of collision may be determined with a number or a type of the collision-related information.

The method may further include, after the step of determining the degree of collision, the step of transmitting a collision notification signal to a mobility device maintenance center or an emergency agency according to a determined degree of the collision.

According to a mobility device sharing service system and method of the present invention, a score is assigned for each user according to whether or not the collision of mobility device occurs and the degree of collision, the score is changed according to the driving style of the user, and a service cost rate is differently charged for each user. Thus, it is possible to enable efficient service provision from the standpoint of service providers, enable service providers to effectively use and manage a mobility device, and enable users to use a sharing service economically and reasonably.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a mobility device sharing service system according to various exemplary embodiments of the present invention.

FIG. 2 is a flow chart of a mobility device sharing service method according to various exemplary embodiments of the present invention.

FIG. 3 is a diagram showing scoring elements for each user of a mobility device sharing service according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

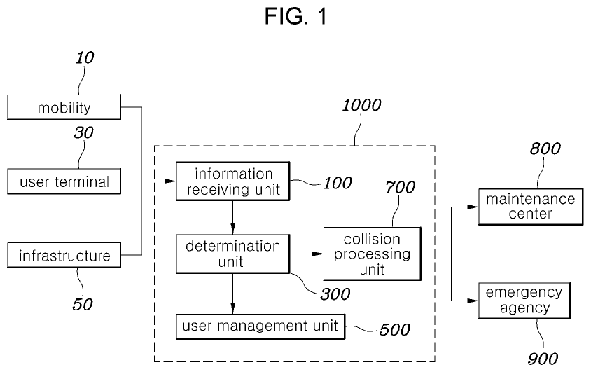

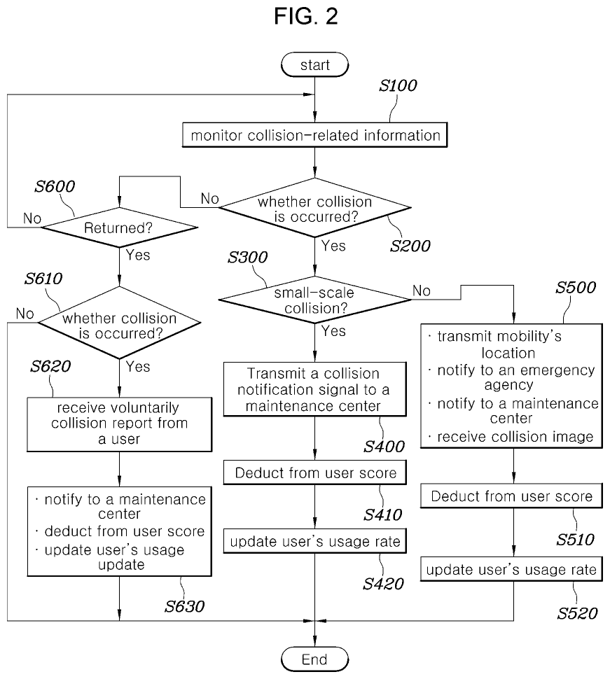

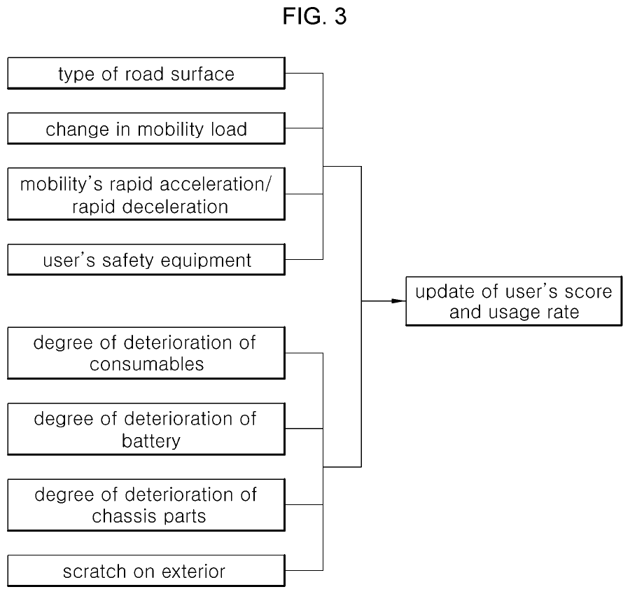

FIG. 1 is a schematic diagram of a mobility device sharing service system according to various exemplary embodiments of the present invention, FIG. 2 is a flow chart of a mobility device sharing service method according to various exemplary embodiments of the present invention, and FIG. 3 is a diagram showing scoring elements for each user of a mobility device sharing service according to various exemplary embodiments of the present invention.

FIG. 1 is a schematic diagram of a mobility device sharing service system according to various exemplary embodiments of the present invention. The mobility device sharing service system according to various exemplary embodiments of the present invention includes an information receiving unit 100 that receives the collision-related information of a mobility device 10 from the mobility device 10, a user terminal 30 or an infrastructure 50 around the mobility device, a determination unit 300 that analyzes the collision-related information of the information receiving unit 100 and measures whether collision has occurred or the degree of collision, and a user management unit 500 that stores user's customer information, the customer information having a score for each user, determines a deduction score based on an occurrence or the degree of the collision analyzed by the determination unit 300, and applies the deduction score to the user's score.

Many mobility device sharing services are emerging to maximize the use of economic resources by renting and sharing mobilities such as vehicles, kickboards, and air mobility device. However, unlike a smart system, there is a problem that requires a person to directly determine whether or not a device is damaged in returning a mobility device device as in an existing process, so it is expensive and difficult to properly repair, manage and correspond. Therefore, if more shared mobility device tools are actively used in the future, it is likely that there is an efficiency problem or undetected damage. Therefore, there is a demand for a system that can effectively determine this.

In order to solve the present problem, the mobility device sharing service system of the present invention detects collisions or damages in mobility device, and automatically records and manages them to enable proper mobility device maintenance, increasing the use of future users and reducing management costs. Furthermore, the maintenance cost of mobility device can be scored and charged individually for each user, so that real economic value is provided to the user and penalties that cause excessive losses to a service provider can be prevented in advance.

Specifically, the mobility device sharing service system of the present invention is provided with a main server 1000. The main server 1000 communicates with each of the mobility device 10, the user terminal 30 or the infrastructure 50 around the mobility device. Through such communication, the collision situation or driving situation of the mobility device 10 is always monitored. Furthermore, the type and degree of collision are identified with provided information, and automatic correspond is performed so that appropriate action can be taken.

Furthermore, information on users is recorded in the main server 1000 to perform individual scoring for each user according to the occurrence of collision or mobility device operating environment, and update customer management data and the cost rate of a sharing service for each customer according to the scoring result.

Specifically, FIG. 1 is a schematic diagram of a mobility device sharing service system according to various exemplary embodiments of the present invention, and FIG. 3 is a diagram illustrating scoring elements for each user of a mobility device sharing service according to various exemplary embodiments of the present invention.

The main server 1000 is provided in the mobility device sharing service system according to various exemplary embodiments of the present invention. Furthermore, the main server 1000 is provided with the information receiving unit 100, the determination unit 300, the user management unit 500, and a collision processing unit 700. The server and various configurations belonging thereto according to the exemplary embodiment of the present invention can be implemented by a processor which is configured to perform the operations to be described below by use of a non-volatile memory configured to store data related to an algorithm or a software instruction for reproducing the algorithm and the data stored in the memory. Here, the memory and the processor may be implemented as separate chips. Alternatively, the memory and processor may be implemented as a single chip integrated with each other, and the processor may be composed of more than one processor.

First, the information receiving unit 100 receives collision-related information of mobility device from the mobility device 10, the user terminal 30 or the infrastructure 50 around the mobility device. Specifically, the collision-related information received by the information receiving unit 100 may include one or more of impact information, noise information, acceleration information, safety equipment information (airbag deployment signal, etc.) of the mobility device 10. That is, it refers to information that can recognize the occurrence of collision through the information. Furthermore, the collision-related information received by the information receiving unit 100 may include at least one of tilt information and noise information of the user terminal.

When a sensor is directly attached to the mobility device 10, the information receiving unit 100 receives impact information, noise information, acceleration information, safety equipment information, and the like of the mobility device from the mobility device 10 via wireless communication. Through this, it is possible to directly determine whether or not there is the collision of the mobility device 10, the degree of the collision, or the state of operation.

Furthermore, the information receiving unit 100 can collect information from the user terminal. The collision-related information received by the information receiving unit 100 may include at least one of tilt information and noise information of the user terminal 30. That is, it is possible to collect information from the sensor inserted in the user terminal 30 via wireless communication with the user terminal. Since the impact on the mobility device 10 can be transmitted to the user terminal 30 through the body, the information of the user terminal 30 may be useful in the case that the sensor is not attached to the mobility device 10.

Furthermore, the information receiving unit 100 can collect information from the infrastructure 50 around the mobility device. In the instant case, it may be the information from the sensor of other mobility device around the corresponding mobility device or information of other infrastructure such as cameras on the road. That is, it is possible to use various surrounding information through V2X technology.

Furthermore, it is possible to make a more accurate determination by combining various types of information obtained from the mobility device 10, the user terminal 30 or the infrastructure 50. That is, the information receiving unit 100 receives collision-related information from the detection sensor of the mobility device 10 and the detection sensor of the user terminal 30, and the determination unit 300 can perform analysis in consideration of the collision-related information of the mobility device 10 and the user terminal 30.

Since collision-related information is analyzed through not only one object but also multiple objects in the above case, it is possible to more accurately determine whether or not the collision has occurred. For example, the sensor of the mobility device 10 may not perfectly perform sensing, or the sensor may fail. Thus, in the case in which a weak impact signal is detected in the mobility device 10, but a strong impact is detected by the user's smartphone or wearable device, it can be considered comprehensively as a strong collision by prioritizing the strong impact.

Through such various information, it is possible to perform effective collision-related determination. To the present end, the determination unit 300 analyzes the collision-related information of the information receiving unit 100 to determine whether collision has occurred or the degree of collision.

Furthermore, the information receiving unit 100 may receive a plurality of types of collision-related information, and the determination unit 300 may determine the degree of collision by analyzing the plurality of types of collision-related information. Through this, the determination unit 300 may determine the degree of the collision with the number or type of collision-related information related to the collision that has occurred. Furthermore, the determination unit 300 may determine the degree of the collision with the time interval of occurrence of collision-related information related to the collision.

In other words, there may be large-scale and small-scale collisions. The determination unit 300 may determine not only the occurrence of such collision, but also the degree of the collision.

For example, when a signal considered to indicate the occurrence of collision in both the sensor of the mobility device 10 and the sensor of the user terminal 30 is detected, or when the same type of signal is received, it can be determined by the determination unit as large-scale collision, rather than small-scale collision.

Furthermore, even when the same type of signals is received continuously within a certain time interval, it can be regarded as large-scale collision. For example, when the impact to right is detected by both the mobility device 10 and the user terminal 30, it may be determined that large-scale collision to the right has occurred. Alternatively, when an impact on the right side is continuously detected by the mobility device 10 within a relatively short time, it is determined that there is a strong impact on the right side, and it can be determined as large-scale collision.

Furthermore, in determining the degree of collision with the number of collision-related information, there may be cases where collision-related information is received from other nearby mobility device in addition to the corresponding mobility device. If the number of other mobility device from which collision-related information is received is identified, it is possible to determine whether a multiple collision situation is occurred and the degree of the collision. Therefore, it is possible to more accurately identify the degree of collision by determining the number of mobility device that provides collision-related information together.

Furthermore, since the information receiving unit 100 receives various types of signals from various objects, the determination unit 300 utilizes them as a whole to accurately and rapidly identify not only the occurrence of collision, but also the degree and degree of the collision or the type of collision.

Meanwhile, the present invention may further include the collision processing unit 700 that transmits a collision notification signal to a mobility device maintenance center 800 or an emergency agency 900 according to the degree of the collision determined by the determination unit 300. The collision processing unit 700 may transmit the collision image received from the mobility device 10 or the user terminal 30 to the mobility device maintenance center 800 when the degree of collision is small. Furthermore, the collision processing unit 700 may transmit the location information of the mobility device 10 or the user terminal 30 to the emergency agency 900 when the degree of collision is not small.

The determination unit 300 determines the occurrence and degree of collision, and the collision processing unit 700 actively responds to each collision with the determination. If collision is determined to be small-scale collision, the black box of the mobility device 10, the photographed image of the user terminal 30, or the photographed image of the surrounding infrastructure 50 is received, and the collision image in which such collision is recorded may be transmitted to the mobility device maintenance center 800. Furthermore, it is also possible to automatically process reservations and maintenance request for repairs to the mobility device service center 800.

If the collision is relatively large and corresponds to large-scale collision, the location of the mobility device 10 is first identified by use of Global Positioning System (GPS) information, and based on this, the emergency agency 900 is automatically contacted to request rescue. Then, the collision image in which the collision is recorded may be transmitted to the mobility device maintenance center 800.

By automatically processing such a series of processes, collision is handled rapidly, labor costs are reduced to save costs, people are rescued rapidly, and mobility device maintenance is performed without errors, so that future users do not experience inconvenience. Accordingly, it is to increase the satisfaction with the overall service.

Furthermore, the user management unit 500 stores the user's customer information in a separate memory. The user's customer information includes a score for each user, and it is possible to reduce or increase the service cost rate (hourly usage fee) of the user in the future by use of the user score. Specifically, the user management unit 500 determines a deduction score based on an occurrence or the degree of the collision analyzed by the determination unit, and updates the user score by applying the deduction score to the user's score.

Furthermore, the user management unit 500 may update the user's cost rate of the mobility device sharing service according to the changed user's score.

A cost for repair is generated in the event of mobility device collision. If time passes without confirming whether collision has occurred, the identification of the party responsible for the collision may become unclear and the cost that a service provider may bear may increase. Furthermore, if this induces an increase in the overall service cost, the overall consumer suffers a disadvantage by the negligence of a specific user. Therefore, in order to manage this economically and efficiently, collision is automatically recognized, received, and repaired, and the burden is transferred to users with negligence, increasing the satisfaction of the entire consumer and facilitating a service provide to provide a stable operation.

Accordingly, in the case of the present invention, in the event of a collision, the user's fault is automatically determined through image analysis, and this is reflected in the user's future cost rate through a score, promoting stable service operation.

Furthermore, in case of aging or deterioration as well as collision, mobility device maintenance is required. Furthermore, consumables may be needed to be replaced. In general, when the user's driving habits are rough or harsh, or when the driving environment is poor, such deterioration is also rapidly progressing. Thus, it will be economical and reasonable for a user to bear some of these maintenance costs.

Specifically, damage to tires, deterioration of accelerator due to rapid acceleration, damage to brake pads due to rapid deceleration, deterioration of battery, or scratches on exterior may also affect the depreciation of mobility device. Therefore, in various exemplary embodiments of the present invention, it is possible to update the user's score and update the cost rate in consideration of driving habits and deterioration of parts as shown in FIG. 3.

Specifically, in the case of the driving habit, the driving habit or environment can be inferred from a road surface, load changes, rapid acceleration or rapid deceleration, and whether the user is wearing safety equipment. Furthermore, the aging of parts can be determined by considering the degree of consumption of consumables, the degree of deterioration of battery, the degree of deterioration of chassis parts, or the scratch on exterior.

FIG. 2 is a flow chart of a mobility device sharing service method according to various exemplary embodiments of the present invention. The service method using the mobility device sharing service system of the present invention may include steps of receiving mobility device collision-related information from the mobility device, the user terminal, or the infrastructure around the mobility device (S100), analyzing the collision-related information of the information receiving unit to determine whether collision is occurred or the degree of the collision by the determination unit (S200, S300), and determining a deduction score by the user management unit based on whether the collision is occurred or the degree of the collision to apply the deduction score to the user's score (S410, S510).

The method may further include, after the step of applying the deduction score to the user's score, the step of updating the user's cost rate of mobility device sharing service according to the user's score changed by the user management unit (S420, S520).

Furthermore, in the step of determining the degree of collision, the degree of collision may be determined by the number or type of collision-related information related to the collision that occurred (S300). Furthermore, after the step of determining the degree of collision, the step of transmitting a collision notification signal to the mobility device maintenance center or emergency agency according to the determined degree of collision (S400, S500) may be further included.

Furthermore, if collision has not occurred, a voluntary report of collision or damage can be received from the user upon returning. This can be provided to the maintenance center, and scoring and rates may be managed accordingly (S600, S610, S620, S630).

According to a mobility device sharing service system and method of the present invention, a score is assigned for each user according to whether or not the collision of mobility device occurs and the degree of collision, the score is changed according to the driving style of the user, and a service cost rate is differently charged for each user. Thus, it is possible to enable efficient service provision from the standpoint of service providers, enable service providers to effectively use and manage a mobility device, and enable users to use a sharing service economically and reasonably.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described in order to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A mobility device sharing service system comprising:
an information receiving unit that receives collision-related information of a mobility device from the mobility device, a user terminal, or an infrastructure around the mobility device;
a determination unit that analyzes the collision-related information of the information receiving unit to determine whether a collision of the mobility device is occurred or a degree of the collision; and
a user management unit that stores user's customer information, the user's customer information having a score for each user, determines a deduction score based on an occurrence or the degree of the collision analyzed by the determination unit, and applies the deduction score to the user's score.

2. The system according to claim 1, wherein the information receiving unit receives the collision-related information from a detection sensor of the mobility device and a detection sensor of the user terminal, and the determination unit analyzes the collision-related information received from the mobility device and the user terminal.

3. The system according to claim 1, wherein the information receiving unit receives a plurality of types of the collision-related information, and the determination unit analyzes the plurality of types of the collision-related information to determine the degree of the collision.

4. The system according to claim 1, wherein the determination unit determines the degree of the collision with a number or a type of the collision-related information.

5. The system according to claim 1, wherein the determination unit determines the degree of the collision with a time interval of occurrence of the collision-related information.

6. The system according to claim 1, further including a collision processing unit that transmits a collision notification signal to a mobility device maintenance center or an emergency agency according to the degree of the collision determined by the determination unit.

7. The system of claim 6, wherein when the degree of the collision is small, the collision processing unit transmits a collision image data received from the mobility device or the user terminal, to the mobility device maintenance center.

8. The system of claim 7, wherein when the degree of the collision is not small, the collision processing unit transmits location information of the mobility device or the user terminal, to the emergency agency.

9. The system of claim 8, wherein when a signal indicating the occurrence of the collision is received by the determination unit from a detection sensor of the mobility device and a detection sensor of the user terminal, the determination unit determines that the degree of the collision is not small.

10. The system of claim 8, wherein when a same type of signal is received by the determination unit from a detection sensor of the mobility device and a detection sensor of the user terminal in a predetermined time interval, the determination unit determines that the degree of the collision is not small.

11. The system of claim 10, wherein when an impact on the mobility device is continuously detected by the mobility device within a predetermined time period, the determination unit determines that the degree of the collision is not small.

12. The system according to claim 1, wherein the collision-related information received from the information receiving unit includes at least one of mobility device impact information, noise information, acceleration information, and safety equipment information.

13. The system according to claim 1, wherein the collision-related information received by the information receiving unit includes at least one of tilt information and noise information of the user terminal.

14. The system according to claim 1, wherein the user management unit updates the user's cost rate of mobility device sharing service according to the user's changed score.

15. A mobility device sharing service method which utilizes the mobility device sharing service system of claim 1, the method including the steps of;
receiving, by the information receiving unit, the collision-related information from the mobility device, the user terminal or the infrastructure around the mobility device;
analyzing, by the determination unit, the collision-related information of the information receiving unit to determine whether the collision is occurred or the degree of the collision; and
determining, by the user management unit, the deduction score based on the occurrence of the collision or the degree of the collision, and applying the deduction score to the user's score.

16. The method of claim 15, further including, after the step of applying the deduction score to the user's score, updating the user's cost rate of mobility device sharing service according to the user's score changed by the user management unit.

17. The method of claim 15, wherein in the step of determining the degree of the collision, the degree of the collision is determined with a number or a type of the collision-related information.

18. The method of claim 15, further including, after the step of determining the degree of the collision, transmitting a collision notification signal to a mobility device maintenance center or an emergency agency according to a determined degree of the collision.
